(19) United States
(12) Patent Application Publication
(10) Pub. No.: US 2005/0061924 A1
(43) Pub. Date: Mar. 24, 2005

(54) Wire holders

(76) Inventor: Peter Hamilton Boyle, Allenstown, Queensland (AU)

Correspondence Address: OLIVE & OLIVE, P.A., 500 MEMORIAL STREET, PO BOX 2049, DURHAM, NC, 27702, US

(21) Appl. No.: 10/491,704

(22) PCT Filed: Oct. 1, 2002
(86) PCT No.: PCT/AU02/01329

(30) Foreign Application Priority Data
Oct. 2, 2001 (AU) PR 7990
Jun. 5, 2002 (AU) PS 2767

(51) Int. Cl. F16L 3/00

(52) U.S. Cl. 248/49

(57) ABSTRACT

A wire holder (10) to attach wire (22) to metal posts known as star pickets (23) which comprise three equi-spaced flanges (24) at least one of which being provided with a plurality of spaced apertures (25). The holder (10) includes a capturing part (12) and an attaching part (19) which may be separate or integral. The capturing part (12) is located about the picket (23) to capture the wire (22) and terminates in first and second ends (13, 14), adapted to be located on opposite sides of the flange (24) adjacent the aperture (25); and the attaching part (19) cooperates with the capturing part (12) to secure the holder (10) to the picket (23). The first and second ends (13, 14) can be of various configurations, including two looped portions through which a U-shaped attaching part (19) may pass through, or a single loop at one end with a pin-like member at the other end.

### TECHNICAL FIELD

This invention relates to wire or line holders and in particular but not exclusively to holders for securing wires or other elongated members to posts for fencing purposes.

### BACKGROUND ART

Fences, particularly in rural areas, are commonly constructed of metal posts known as star pickets which comprise three equi-spaced flanges, at least one of the flanges being provided with a plurality of spaced apertures therein with lengths of wire being attached to the respective pickets. Usually, the wire is under tension being strained between end supporting posts. The wire may comprise barbed wire or plain wire or alternatively electrified wire to form an electrified fence and usually the fence is multi-stranded. The fencing wire is required to be tied off at each post and this is conventionally achieved by passing short lengths of stiff tie wires through the respective apertures in the posts and wrapping opposite ends of the wire around the fencing wire. This is obviously a very time consuming and labour intensive process. Removal of the tie wires is also difficult if replacement of the fencing wire is required or restraining is necessary. Tying off of electrified wire poses particular problems as that wire is required to be insulated from the pickets.

### SUMMARY OF THE INVENTION

The present invention aims to provide a wire or line holder particularly but not exclusively suited for attaching fencing wire or line to posts or pickets of the type as herein before described which is relatively simple to apply and which will provide an effective and secure attaching means for the wire or line. Other objects and advantages of the invention will become apparent from the following description.

According to the present invention, there is provided a holder for attaching a fencing wire, line or the like to a post having a portion having at least one aperture therein, said holder including a capturing part and an attaching part, wherein:
said capturing part is adapted to be located about and capture said fencing wire or line and terminates in first and second ends;
said first and second ends are adapted to be located on opposite sides of said post portion adjacent said aperture;
at least one of said ends has an end portion adapted to be aligned with or extend through said aperture in said post portion; and
said attaching part is adapted to co-operate with said capturing part to secure said holder to said post.

Said capturing part may be in the form of a loop and may be further or alternatively adapted to capture an insulating block through which an electrified wire may pass.

Said attaching part, when co-operating with said capturing part, may be adapted to prevent or restrain movement of said first and second ends away from each other to resist detachment of said holder from said post.

In one preferred form of the present invention, said attaching part is separate from said capturing part.

In another preferred form of the present invention, said attaching part is integral with said capturing part.

In those embodiments wherein said attaching part is separate from said capturing part:
each of said first and second ends terminate in a respective substantially looped portion and said attaching part is adapted to pass through each of said looped portion and said aperture;
said first and second ends are either spaced apart at least the width of said post portion so as to be located on said opposite sides of said post portion, or are adapted to be forced apart in use to locate on said opposite sides of said post portion; and
preferably, said attaching part is of U-shaped configuration and is wider than the width of said post portion plus said first and second ends such that the legs of said attaching part span, and retain therebetween, said first and second ends sufficient to resist detachment of said holder from said post.

In those embodiments of the present invention wherein said attaching part and said capturing part are formed integrally:
said first end may terminate in a substantially looped portion;
when said first end terminates in a substantially looped portion, said attaching part includes said second end, said second end terminating in a pin-like member which, when said holder is in use, is adapted to pass through said aperture and extend into said looped portion;
preferably, said pin-like member is biased to extend into said looped portion and is of sufficient resilience to resist detachment of said holder from said post;
preferably, said capturing part, near said first end having said looped portion, is provided with a shoulder spaced from said looped portion a distance sufficient to abut, in use, a side edge of said post portion adjacent said aperture therein to support said holder to prevent it from pivoting downwardly about said post aperture under load;
said first end may be adapted to pass through said aperture and is of a configuration such that, when located within said aperture, its withdrawal therefrom is constrained;
preferably, said configuration is such that, when said first end is located within said aperture, said first end is constrained against its detachment axially of said aperture or in a direction at right angles to the axis of said aperture;
said first end may be configured to include a stepped tongue or hook having a first part which, in use, extends through and is located within said aperture, and a second leading part which is located behind said aperture;
said second end may terminate in a pin-like member which, when said holder is in use, is adapted to pass through said aperture;
preferably, said first and second ends are resiliently biased towards each other.
preferably, said holder is further provided with a shoulder spaced from said first end a distance sufficient to abut, in use, a side edge of said post portion adjacent said aperture therein to support said holder to prevent it from pivoting downwardly about said post aperture under load;
   All components of the holder of the present invention can be manufactured from any suitable material(s) known in the art and typically include a stiff resilient wire or strip-like material which may be of metal or plastic or a combination thereof.

### BRIEF DESCRIPTION OF THE DRAWINGS

In order that the invention may be more readily understood and put into practical effect, reference will now be made to the accompanying drawings which illustrate preferred embodiments of the invention and wherein:

FIG. 1 illustrates, in perspective view, the components of a first holder according to the present invention;

FIG. 2 illustrates two holders of FIG. 1 in an operative engagement with a star picket and holding fencing wires;

FIG. 3 is a view showing a star picket in cross section at an aperture therein and the form of engagement of the first holder of FIG. 1 with the picket;

FIG. 4 illustrates, in perspective view, a second holder according to the present invention;

FIG. 5 illustrates, in perspective view, an insulating block for use with the holder of FIG. 4;

FIG. 6 illustrates two holders of FIG. 4 engaged with a star picket and holding fencing wires;

FIG. 7 is a view showing a star picket in cross section at an aperture therein and the form of engagement of the second holder with the picket;

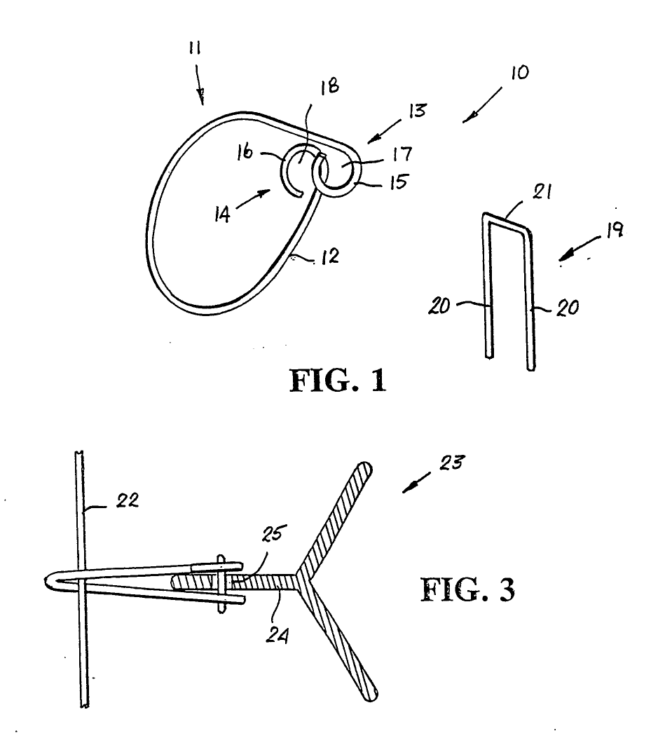

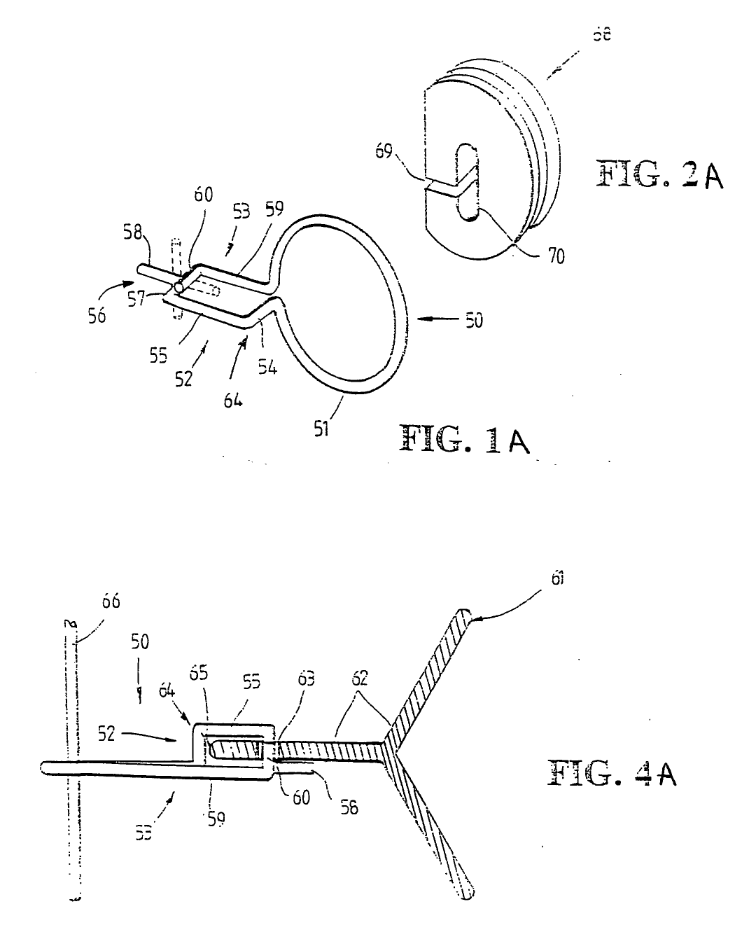

FIG. 1A illustrates, in perspective view, a third holder according to the present invention;

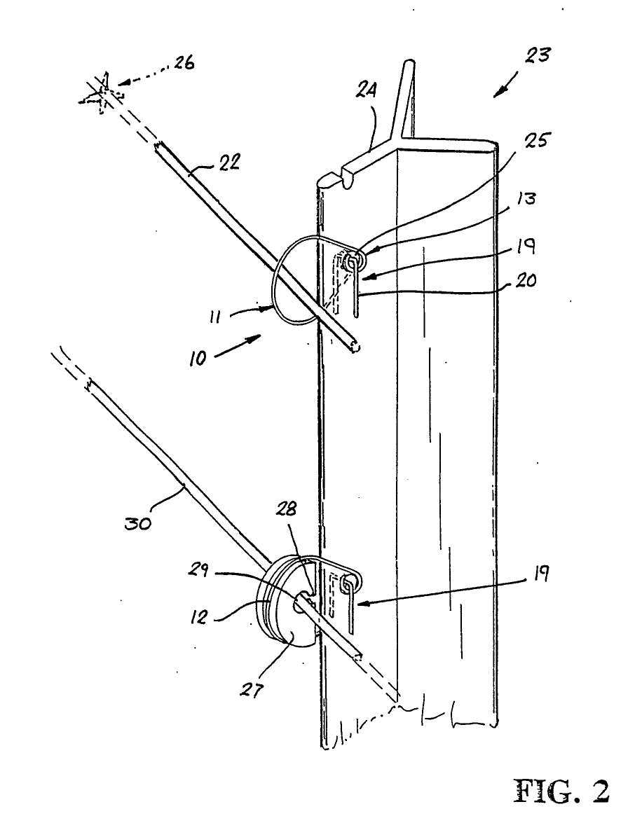

FIG. 2A illustrates, in perspective view, an insulating block for use with the holder of FIG. 1A;

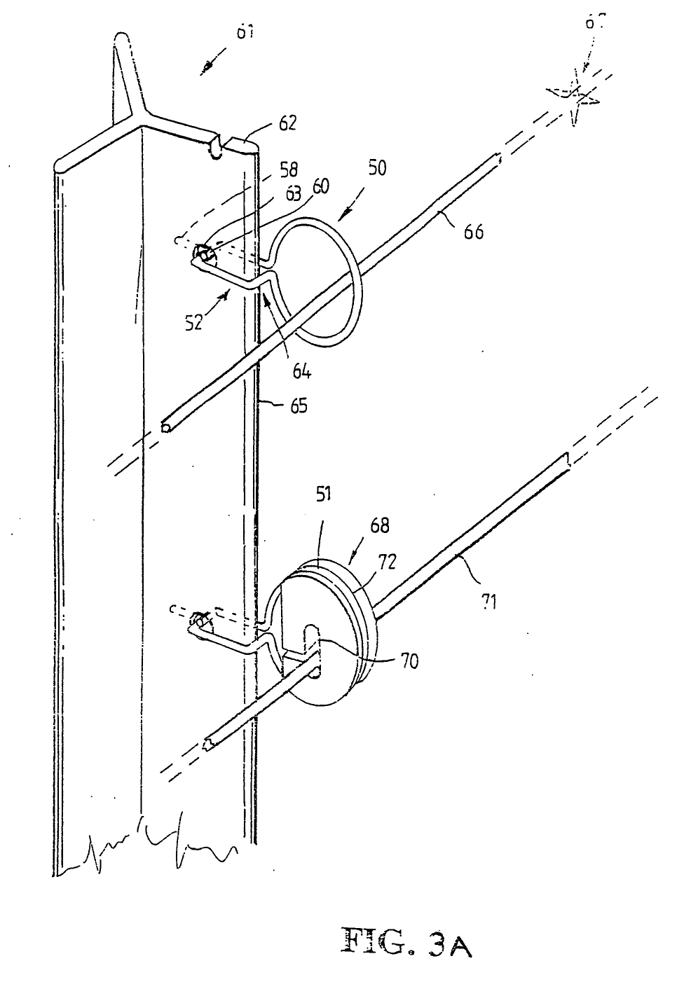

FIG. 3A illustrates three holders of the form shown in FIG. 1A engaged with a star picket and holding fencing wires; and

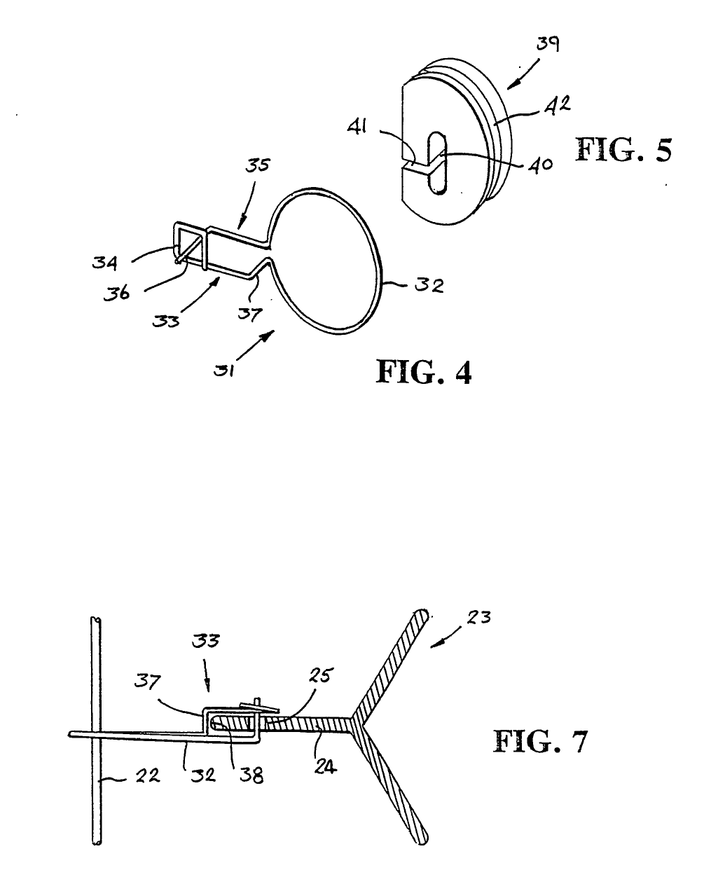

FIG. 4A is a view showing a star picket in cross-section at an aperture therein and the form of engagement of the third holder with the picket.

### DETAILED DESCRIPTION OF THE PREFERRED EMBODIMENTS

Referring to the drawings FIGS. 1-7 and firstly to FIG. 1, there is illustrated the components of a holder 10 according to an embodiment of the invention which is in the form of a clip and comprising a first member 11 formed typically of wire and having a looped generally circular main portion 12 which terminates in opposite free ends 13 and 14. The ends 13 and 14 are turned back on themselves to define opposite return hooks 15 and 16. The ends 13 and 14 are spaced apart a distance to locate over a flange of a star picket as described further below and the hooks 15 and 16 are substantially laterally aligned. Whilst the ends 13 and 14 are shown to be in the form of hooks 15 and 16, it will be appreciated that the hooks 15 and 16 may be fully closed to form eyes. In either case, openings 17 and 18 are formed in the ends 13 and 14. The clip 10 also includes a second member 19 which is again typically formed of wire and of a generally U-shaped configuration including opposite legs 20 joined to and integral with a cross member 21.

In use, one of the legs 20 of the member 19 is inserted into the aligned openings 17 and 18 defined by the hooks 15 and 16 until the cross member 21 is located in the hook opening 17 and 18. The legs 20 are spaced apart a distance greater than the distance between the hooks 15 and 16.

The clip 10 as shown in FIGS. 2 and 3, is primarily designed for attaching a fencing wire 22 to a star picket 23 of conventional form having three angled flanges, one of which 24 has a series of apertures 25 at spaced positions therealong. The clip member 11 is initially placed over the wire 22 which locates within the looped main portion 12. The ends 13 and 14 are then positioned on opposite sides of the flange 24 at the location of one of the apertures 25 and such that the openings 17 and 18 of the hooks 15 and 16 are substantially aligned with the aperture 25. The member 19 is then inserted into the openings 17 and 18 and aperture 25 and released to adopt a generally vertical hanging attitude with the legs 20 located on opposite side of the flange 24 and the cross member 21 extending through the hooks 13 and 14 and flange 24. The looped portion 12 in this position is substantially upright with the axis through the looped portion generally horizontal.

By the above arrangement, the wire 22 is secured to the star picket 23 as the ends 13 and 14 of the member 11 are prevented from moving apart by the legs 20. The member 11 can only be detached from the picket 23 by extracting the member 19. It may be necessary for this purpose to urge the legs 20 apart to effect detachment of the member 19.

The clip 10 may be used for securing the plain wire to star pickets 23 or alternatively may be used in the same manner for securing a barbed wire 26 (shown in dotted outline) to pickets 23. Additionally, the clip 10 may be used for securing an electrically charged wire to pickets 23 for the purposes of constructing an electric fence. For the latter purpose, an insulation block 27 made of plastics or other insulating material is located within the looped portion 12 of the main portion 11 of the clip member 11. The block 27 has a slot 28 leading into a central aperture 29 in the block 26 into which an electrical fence wire 30 can be passed to be captured. The block 27 has a groove in its periphery for receipt of the looped portion 12. The clip 10 is then attached to the picket 23 in the same manner as described above with the insulation block 27 insulating the wire 30 from the picket 23.

Referring now to FIGS. 4 & 5, there is illustrated a further wire holder in the form of clip 31 according to another embodiment of the invention which is one piece and suitably formed of a relatively stiff resilient wire. The clip 31 includes a main looped portion 32 of generally circular form terminating in a first end 33 defining an eye 34 formed by folding the end 33 back upon itself and a second end 35 defining a pin-like member 36. The end 33 is stepped outwardly from the main looped portion 32 at shoulder 37 with the distance between the eye 34 and shoulder 37 being approximately the same or a slightly greater distance than the distance between the aperture 25 in a star picket 23 and the outer edge of the flange 24 thereof for a purpose which will hereinafter become apparent. The other end 35 extends from the looped portion 32 generally parallel to the end 33 except at the pin-like member 36 which is turned inwardly substantially at right angles to the end 33 and eye 34.

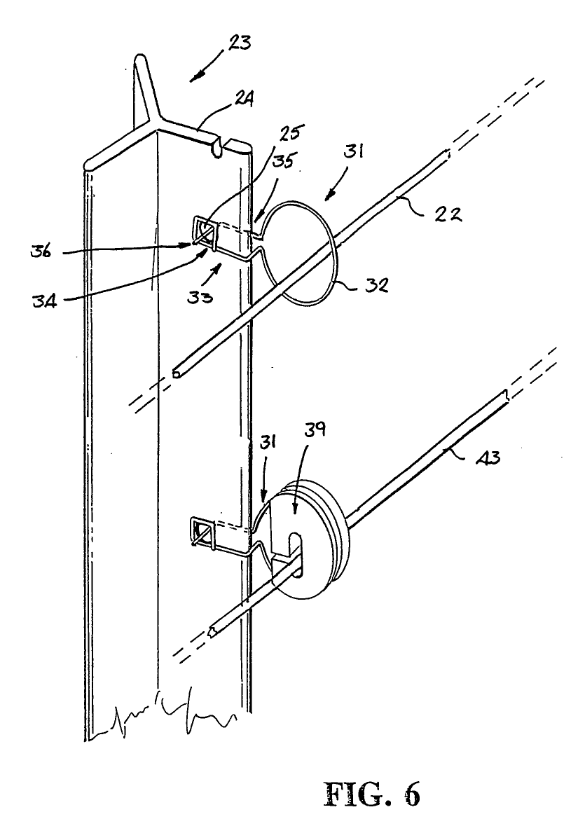

In use, as shown in FIGS. 6 and 7, the ends 33 and 35 may be moved resiliently apart to pass about a fencing wire 22 which will thus locate within the main looped portion 32. The end 33 is then positioned on one side of the flange 24 and the eye 34 is aligned with the aperture 25 whilst the end 35 is positioned on the other side of the flange 24 with the pin-like member 36 being aligned with the aperture 25 and eye 34. When released, the resilience of the material of the clip 31 will force the pin-like member 36 through the aperture 25 in the picket flange 24 and eye 34 to thus retain the clip 31 to the star picket 23 and attach the wire 22 thereto. When the clip 31 is held to the star picket 23 as described, the shoulder 37 will abut the edge 38 of the flange 24 which will prevent the clip 31 from swinging downwardly under load. It will also be apparent that when the clip 31 is attached as above, the looped portion 32 is substantially upright to capture the wire 22.

For release of the wire 22, the ends 33 and 35 may be simply forced apart to release the pin-like member 34 from the eye 33 and aperture 25 and then the wire 22.

Typically, where the clip 31 is used with a star picket 23 of the type having flange apertures spaced 16 mm from the longitudinal edge of the flange 24, the distance between the eye 34 and shoulder 37 is also approximately 16 mm and the shoulder 37 is preferably of a width of approximately 5 mm. The looped portion 32 is preferably of a diameter of approximately 26 mm and the pin-like member 36 of approximately 12 mm in length. The eye 34 may be of any form such as rectangular or circular or simply may be in the form of a hook.

As with the embodiment of FIGS. 1 to 3, the clip 31 may be used for securing a plain wire or a barbed wire to the picket 23. The clip 30 may also be used to secure an electrified wire to the picket 23 by means of an insulation block 39 (see FIG. 5), the lafter having an opening 40 and a slot 41 leading into the opening 40 through which the electric wire 33 may be passed. The insulation block 36 is externally grooved to receive the looped portion 32 of the clip 31 which resiliently engages the block 36 and captures the block 32 when the clip 31 is secured to the picket 23 in the same manner as described above.

The clips 10 and 32 may be used for attaching any form of wire or line to star pickets and for some requirements, clips 10 and 32 may be used for attaching both an electrified and non-electrified wire to the picket. The clips 10 and 32 additionally may be used with other forms of post which have openings and which are configured such as to enable a clip 10 or 32 to be engaged therewith.

Typically, the clips 10 and 32 are formed of wire, typically a resilient wire. However, the clips may also be formed of other materials such as strip like materials. It is also possible to form the clips 10 and 32 of plastics material or a combination of metal and plastics.

The clips 10 and 32 may be installed to hold wires or lines to the posts before the wires are strained. Alternatively, the clips 10 and 32 may be installed to hold strained wires to posts. It will also be appreciated that both forms of clip 10 and 32 may be readily attached and detached to posts as required.

Referring now to the drawings FIGS. 1A-4A and firstly to FIG. 1A, there is illustrated a holder 50 according to an embodiment of the invention, the holder 50 being a clip-like member and being formed in one piece typically of relatively stiff resilient wire and having a looped main portion 51 which terminates in opposite free ends 52 and 53.

The first end 52 includes a first portion 54 which extends generally at right angles to one side of the looped main portion 51 and substantially parallel to the axis thereof and a second arm portion 55 which extends from the first portion 54 and in a direction away from the looped main portion 51 but substantially parallel to the plane of the looped main portion 51. A stepped integrally formed tongue- or hook-like member 56 is provided at the end of the arm portion 55 defined by a portion 57 extending substantially at right angles from the second portion 55 and substantially parallel to the first portion 54 and a fourth lead-in portion 58 which extends substantially at right angles from the third portion 56. In the embodiment illustrated, the lead-in portion 58 extends substantially parallel to the arm portion 55 but may extend in any direction from the third portion 57 as illustrated for example in dotted outline in FIG. 1A. The configuration of the tongue or hook-like member 56 is such that when inserted into an aperture, it can only be detached by pivoting it to move the lead-in portion 58 towards a position in alignment with the aperture and it cannot be detached from the aperture by simple movement axially of, or at right angles to, the aperture.

The other free end 53 of the holder 10 extends in the same direction as the end 52 and includes an arm portion 59 which extends from the looped portion 51 generally in the plane of the portion 51 and substantially parallel to the arm portion 55. The arm portion 59 terminates in an end portion in the form of an inwardly turned pin-like member 60 which is substantially at right angles to the plane of the looped portion 51 and which extends towards the end 52.

The clip-like holder 10 is adapted to be used with a post such as a star picket 61 (see FIGS. 3A and 4A) having three radially spaced flanges 62, one of which is provided with a series of longitudinally spaced apertures 63. The first and second portions 54 and 55 of the end 52 form a shoulder 64 which is spaced from the tongue-like member 56 a distance approximately the same as or slightly greater distance than the distance between an aperture 63 in the flange 61 and the outer edge 65 of the flange 61 thereof for a purpose which will hereinafter become apparent.

In use and for attaching a fencing wire 66 to the star picket 61, the ends 52 and 53 of the holder 50 may be moved resiliently apart to pass about the fencing wire 66 which will thus locate within the main looped portion 51. The end 52 is then positioned on one side of the flange 62 containing the apertures 63 and angled such that the lead-in portion 58 can pass through the aperture 63 and locate on the opposite side of the flange 62 with the third portion 57 extending through and being located within the aperture 63. At the same time, the pin-like member 60 of the other end 53 is aligned with the aperture 63 such that when the end 53 is released, the resilience of the material of the holder 50 will force the pin-like member 60 into the aperture 63 in the picket flange 62. The cooperation between the ends 52 and 53 with the aperture 63 prevents detachment of the holder 50 from the star picket 61 and thus securely attaches the wire 66 to the star picket 61. When the holder 50 is engaged with the star picket 60 as described, the shoulder 64 will abut the edge 65 of the flange 62 which will prevent the holder 50 from swinging downwardly under load. It will also be apparent that when the holder 50 is attached as above, the looped portion 51 is substantially upright with the axis through the looped portion generally horizontal to capture the wire 66.

For release of the wire 66, the end 53 is forced away from the picket flange 62 to release the pin-like member 60 from the aperture 63 and the holder 50 may then be manipulated so as to enable the tongue-like member 56 to be withdrawn from the aperture 63. The ends 52 and 53 may then be moved apart to release the wire 66.

The holder 50 may be used for securing the plain wire 66 to star pickets 61 or alternatively may be used in the same manner for securing a barbed wire 67 (shown in dotted outline) to pickets 61. Additionally, the holder 50 may be used for securing an electrically charged wire to pickets 61 for the purposes of constructing an electric fence. For the latter purpose, an insulation block 68 made of plastics or other insulating material (see FIG. 2A) is located within the looped portion 51 of the holder 50. The block 68 has a slot 69 leading into a central aperture 70 in the block 68 into which an electrical fence wire 71 can be passed to be captured. The block 68 has a groove 72 in its periphery for receipt of the looped portion 51, the looped portion 51 of the holder 50 resiliently engaging the block 68 and capturing the block 68. The holder 50 is then attached to the picket 61 in the same manner as described above and as shown in FIG. 3A with the insulation block 68 insulating the wire 71 from the picket 61. Typically, where the holder 50 is used with a star picket 61 of the type having flange apertures 63 spaced 16 mm from the longitudinal edge of the flange 61, the distance between the tongue-like member 56 and shoulder 64 is also approximately 16 mm and the shoulder 64 is preferably of a width of approximately 5 mm. The looped portion 51 is preferably of a diameter of approximately 26 mm. However, of course, it is not necessary that the looped portion 51 be circular. The above dimensions, of course, may be varied.

The holder 50 may be used for attaching any form of wire or line to star pickets and, in some cases, holders 50 may be used for attaching both an electrified and non-electrified wire to the picket. The holders 50 additionally may be used with other forms of post which have openings and which are configured such as to enable a holder 50 to be engaged therewith.

Typically, the holders 50 are formed of wire, typically a stiff resilient wire. However, the holders 50 may also be formed of other materials such as strip like materials. It is also possible to form the holders 50 of plastics material or a combination of metal and plastics.

The holders 50 may be installed to hold wires or lines to the posts before wires are strained. Alternatively, the holders 50 may be installed to hold strained wires to posts.

Whilst the above has been given by way of illustrative embodiments of the invention, all variations and modifications thereto as would be apparent to persons skilled in the art are deemed to fall within the broad scope and ambit of the invention as defined in the following claims.

1. A holder for attaching a fencing wire, line or the like to a post having a portion having at least one aperture therein, said holder including a capturing part and an attaching part, wherein:
said capturing part is adapted to be located about and capture said fencing wire or line and terminates in first and second ends;
said first and second ends are adapted to be located on opposite sides of said post portion adjacent said aperture;
at least one of said ends has an end portion adapted to be aligned with or extend through said aperture in said post portion; and
said attaching part is adapted to co-operate with said capturing part to secure said holder to said post.

2. A holder as defined in claim 1 wherein said capturing part is in the form of a loop.

3. A holder as defined in claim 2 wherein said capturing part is adapted to capture an insulating block through which an electrified wire may pass.

4. A holder as defined in claim 1 wherein said attaching part, when co-operating with said capturing part, is adapted to prevent or restrain movement of said first and second ends away from each other to resist detachment of said holder from said post.

5. A holder as defined in claim 1 wherein said attaching part is separate from said capturing part.

6. A holder as defined in claim 1 wherein said attaching part is integral with said capturing part.

7. A holder as defined in claim 5 wherein each of said first and second ends terminate in a respective substantially looped portion and said attaching part is adapted to pass through each of said looped portion and said aperture.

8. A holder as defined in claim 5 wherein said first and second ends are spaced apart at least the width of said post portion so as to be located on said opposite sides of said post portion.

9. A holder as defined in claim 5 wherein said first and second ends are adapted to be forced apart in use to locate on said opposite sides of said post portion.

10. A holder as defined in claim 5 wherein said attaching part is of U-shaped configuration and is wider than the width of said post portion plus said first and second ends such that the legs of said attaching part span, and retain therebetween, said first and second ends sufficient to resist detachment of said holder from said post.

11. A holder as defined in claim 6 wherein said first end terminates in a substantially looped portion.

12. A holder as defined in claim 11 wherein said attaching part includes said second end, said second end terminating in a pin-like member which, when said holder is in use, is adapted to pass though said aperture and extend into said looped portion.

13. A holder as defined in claim 12 wherein said pin-like member is biased to extend into said looped portion and is of sufficient resilience to resist detachment of said holder from said post.

14. A holder as defined in claim 11 wherein said capturing part, near said first end having said looped portion, is provided with a shoulder spaced from said looped portion a distance sufficient to abut, in use, a side edge of said post portion adjacent said aperture therein to support said holder to prevent it from pivoting downwardly about said post aperture under load.

15. A holder as defined in claim 6 wherein said first end is adapted to pass through said aperture and is of a configuration such that, when located within said aperture, its withdrawal therefrom is constrained.

16. A holder as defined in claim 15 wherein said configuration is such that, when said first end is located within said aperture, said first end is constrained against its detachment axially of said aperture.

17. A holder as defined in claim 15 wherein said configuration is such that, when said first end is located within said aperture, said first end is constrained against its detachment in a direction at right angles to the axis of said aperture.

18. A holder as defined in claim 15 wherein said first end is configured to include a stepped tongue or hook having a first part which, in use, extends through and is located within said aperture, and a second leading part which is located behind said aperture.

19. A holder as defined in claim 15 wherein said second end terminates in a pin-like member which, when said holder is in use, is adapted to pass through said aperture.

20. A holder as defined in claim 15 wherein said first and second ends are resiliently biased towards each other.

21. A holder as defined in claim 15 wherein said holder is further provide with a shoulder spaced from said first end a distance sufficient to abut, in use, a side edge of said post portion adjacent said aperture therein to support said holder to prevent it from pivoting downwardly about said post aperture under load.

22. A holder as defined in claim 1 manufactured from stiff resilient wire.

23. A holder as defined in claim 22 wherein said wire is manufactured from metal.

24. A holder as defined in claim 22 wherein said wire is manufactured from a plastics material.

25. A holder as defined in claim 22 wherein said wire is manufactured from metal coated with a plastics material.
